(19) United States
(12) Patent Application Publication
(10) Pub. No.: US 2015/0379720 A1
(43) Pub. Date: Dec. 31, 2015

(54) METHODS FOR CONVERTING TWO-DIMENSIONAL IMAGES INTO THREE-DIMENSIONAL IMAGES

(71) Applicant: THREEVOLUTION LLC, Miami, FL (US)

(72) Inventor: Antonio Bejar HERRAEZ, Granada (ES)

(21) Appl. No.: 14/765,168

(22) PCT Filed: Jan. 31, 2014
(86) PCT No.: PCT/US2014/014224

§ 371 Date: Jul. 31, 2015

Related U.S. Application Data
(60) Provisional application No. 61/759,051, filed on Jan. 31, 2013.

(51) Int. Cl. G06T 7/00; H04N 13/02

(52) U.S. Cl. CPC G06T 7/0069; H04N 13/026; G06T 2207/10016; G06T 2207/20092; G06T 2207/20221

(57) ABSTRACT

A method for obtaining a depth map for conversion of 2-dimensional images to 3-dimensional images is provided. Input marks are overlayed on an image that segment the image into one or more zones. The method further provides assigning zone depth values for each of the zones and generating one or more cue related depth values that are weighting with each of the zone depth values to obtain an average depth value and final depth map of the image.

### BACKGROUND

In human stereo vision, each eye captures a slightly different view of the scene a human sees. The reason of the difference in the two images, also called disparity, is due to the baseline distance between the eyes of the viewer. When these two images are processed by the human brain, these disparities (along other visual cues such as perspective, image blurring, etc.) allow the observer to get a sense of depth in the observed scene.

Getting two views of the same scene and presenting each eye with the corresponding image gives the user a three-dimensional (3D) experience. There are 3D television sets available that provide such an experience; however, they generally require the proper 3D content.

If one captures a stereo pair of a scene, which is as easy as taking a shoot of the scene with two cameras located by a sufficient baseline to account for the distance between the eyes of an average human viewer and then packing the obtained information in a standard format, the shoot can be seen in 3D.

There are other methods for getting a 3D experience. As in movie theaters, two projectors and a silver screen can be used. One projector projects the left eye image and the other the right one. The key here is using the polarization properties of light. Using different polarization settings of each of the projectors provides that, when the human viewer wears special polarized glasses, the left eye will see only the left image and the right eye will perceive only the right image. Proper filming of 3D content requires that the cameras are perfectly synchronized, and accuracy is a must, which is not 100% obtainable typically. Many other factors must be taken into account. For instance, shoots need to be filmed with a right baseline. A scene consisting of two people talking in the foreground of the scene and very close to the camera will require a particular camera setting, very far apart from an outdoor scene focusing on the far trees in a landscape. Many other technical parameters must be defined in the scene before shooting. This additional work makes 3D production more expensive than traditional two-dimensional (2D) movie making.

On the other hand, there exists a very large library of 2D films, documentaries, etc., that were captured with only one camera. Various laborious and expensive methods have been attempted to convert these 2D streams into three dimensional image streams. Creating a sequence of stereo image pairs from a sequence of images captured from a single camera is a very difficult undertaking. To construct the second eye image from the original image, the process must carefully mimic the differences a human visual system would expect to perceive regarding the depth from the constructed stereo pair. Any little mistake will make the depth perception fail. Moreover, this new view construction must be consistently propagated along the rest of the frames of the sequence. As such, converting a conventional 2D movie into 3D actually involves 300-500 people working on the frames of the film, which can typically take about a year to complete.

Current systems and methods for making 2D to 3D conversions focus on giving the user of a software application a set of very sophisticated editing tools for obtaining a high quality depth map for the image to convert. The user of the conversion software, also called an “artist” in the context of visual content post production, tells the system the distance from the camera for each element in the scene. Given the distance to the camera of every object in the scene, generating a new view is an easier task. Software implemented in these systems is a very sophisticated editing tool which saves time for making 2D to 3D conversions. All decisions about the 3D structure of the scene in the image have to be provided by the human operator. The common way to tell the software what objects in the scene are closer to the camera and what others are farther away is to select with a mouse or other input device the contours of a specific shape and give it the appropriate depth value. This procedure has to be done for every object in the scene.

On the other hand, there are technologies related to very specific ways for obtaining 3D information from a single image or from a sequence of images from a clip video. These procedures for obtaining 3D structure from the conventional 2D material utilize visual cues. These cues include blur from defocus, texture variation, perspective, convexity and occlusions. If a set of consecutive images in time is being analyzed (a sequence from a clip), another important source of information is motion analysis.

Algorithms implementing the aforementioned visual cues work fine in the ideal case; however, the real world situation is a little different. Extracting 3D structure information from a single image using the blur from defocus cues will not work well if an image was obtained with a large depth of field camera (where everything in the picture is well focused). If using motion analysis of a scene when a set of consecutive frames is given, such as e.g., when the scene consists of a stationary camera with an actor in the foreground of the scene and land with a fast running car in the background, preliminary motion information will not suit 3D structure information needs. Furthermore, using any of these cues alone won't give a reliable depth map in general situations. Using structure from motion will work if the camera is moving in a translational movement and everything is stopped. The larger the magnitude of optical flow the closer the object is. But, this will not be the general situation where there are a lot of objects moving in different directions at the same time. The same happens to depth from defocus cues. If the camera is focusing on a middle distance object, the traditional algorithms will output that the closer objects are the same distance as the far away object in the background. Even when relative height is used, if only a face of somebody appears at a middle distance from the left side, the object will occlude things in the scene, but according to this cue alone the algorithm will say the face is behind things with lower relative high.

### BRIEF SUMMARY

Methods for obtaining 3D information from a single 2D image or a stream of 2D images from a video clip or film are described. The methods enable depth analyses utilizing monocular cues.

Methods are provided that utilize scribbles (i.e., input marks) overlaid on an input image for segmenting various foreground objects and parts of background with information about the desired depth. Along with depth information, the scribbles also convey static/dynamic attributes for objects in the image. The provided information is used to tune the parameters of various depth maps obtained by a particular visual cue to improve its reliability. The set of depth maps is equally weighted for a final average, and a final depth map is generated.

In one aspect, a method for obtaining a depth map is provided. The method comprises receiving one or more image; receiving one or more input marks overlaid on the one or more image that segment the one or more image into one or more zones; assigning zone depth values for each of the zones; generating cue related depth values utilizing the zone depth values and one or more cue related depth values; weighting each of the zone depth values and one or more cue related depth values to obtain an average depth value; and generating a depth map of the image from the average depth values.

In some embodiments, the one or more cue related depth values are generated utilizing the assigned zone depth values for each of the zones. Furthermore, the one or more cue related depth values can be selected from a motion cue value, a relative height cue value, an aerial perspective cue value, a depth from defocus cue value, and combinations thereof.

In some embodiments, the one or more input marks segment the image into static or dynamic objects in the image and/or a zone containing one or more foreground objects and/or background objects.

In another aspect, computer-readable storage medium having instructions stored thereon that cause a processor to perform a method of depth map generation is provided. The instructions comprise steps for performing the methods provided herein, including, in response to receiving one or more input marks overlayed on one or more image that segment the image into one or more zones, assigning zone depth values for one or more of the zones; generating one or more cue related depth values; weighting each of the zone depth values and one or more cue related depth values to obtain an average depth value; and generating a depth map of the one or more images from the average depth values. The cue related depth values can be selected from the group consisting of a motion cue value, a relative height cue value, an aerial perspective cue value, a depth from defocus cue value, and combinations thereof.

In some embodiments, the one or more input marks segment the image into static or dynamic objects in the image and/or into a zone containing one or more foreground objects and/or into a zone containing one or more background objects.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 illustrates a functional diagram of steps for obtaining a depth map and stereoscopic pair from a 2D image;

FIG. 2 illustrates modular views of various visual cues utilized for generating an average depth map in at least one embodiment of the present invention;

FIG. 3 illustrates exemplary aspects of a perspective cue;

FIG. 4 is a lens diagram illustrating the depth of a focus visual cue;

FIG. 5 illustrates a functional diagram of steps for obtaining a depth map utilizing scribbles in combination with the depth from defocus visual cue;

FIG. 6 is illustrative of a convexity/curvature cue;

FIG. 7 is illustrative of the derivation of a depth map for isophotes of value T;

FIG. 8 illustrates a functional diagram of steps for obtaining a depth map utilizing scribbles in combination with the relative height visual cue;

FIG. 9 illustrates a functional diagram of steps for obtaining a depth map utilizing scribbles in combination with a motion visual cue;

FIG. 10A illustrates an exemplary interface for editing an input two-dimensional image;

FIG. 10B illustrates an operating environment in which certain implementations of the methods of converting two-dimensional images into three-dimensional images may be carried out;

FIG. 11 illustrates an exemplary interface showing final depth map determinations for an image utilizing the methods described.

### DETAILED DESCRIPTION

The present invention will now be described more fully in the description provided herein. It is to be understood that the invention may be embodied in many different forms and should not be construed as limited to the embodiments set forth herein. Rather, these embodiments are provided so that this disclosure may be thorough and complete, and will convey the scope of the invention to those skilled in the art.

The present invention includes methods for conversion of 2D frames (images) into 3D frames (images) by using input marks overlaid on the image (called “scribbles” interchangeably herein) for segmenting different foreground objects and sparse parts of background with information about the desired depth or for simply segmenting the frame. Along with depth information, the scribbles also convey static/dynamic attributes for each scribble and designated zone, or shape, in the picture. In some embodiments, in a first step, when providing scribbles, the whole zone is assigned a single depth value, that is, every pixel belonging to a zone is assigned the same depth value. Subsequently, using various visual cues, every pixel in the zone is assigned particular increment/decrement values around the initial depth. For example, when segmenting a sphere in a frame, scribbles will provide a disk in the depth map. Later, employing visual cues, convexity and motion cues (if there's motion) will determinate if the central part is closer to camera than edges zones.

The provided information is used to tune the parameters of each depth map obtained by a particular visual cue to improve its reliability. Finally, this set of depth maps is equally weighted for a final average such that a final depth map is generated.

Obtaining an intermediate depth map created from a weighted contribution from two or more system-proposed depth maps from varying cues is also possible in some embodiments of the present invention. For example, it is possible for a general structure of the scene to be given by a perspective visual cue and then the particular three dimensional structure of people standing at the image can be better obtained via a convexity cue.

In addition, when working on the first of the images from a particular scene to be converted, embodiments of the invention allow the final depth map to be received, and the methods and software may automatically propagate the initial depth map along the scene according to evolution in time of all objects in the scene and camera movement.

In some embodiments, when the final depth map is generated, the virtual view is generated to provide the stereoscopic left-right pair. Input switches tell the system about any disparity such that larger or shorter depth in the scene is experienced. In some embodiments, another set of switches allow modification and receiving of the perceived distances among objects in the scene. Finally, a last set of switches of the system function to assist in avoiding jagging effects when rendering a virtual image from a depth map. These switches may be, among others, morphological dilation of image segments near the edges, edge preserving smoothing, etc.

As used herein, the terms “depth map” refer to a grayscale image that contains information relating to the distance of the surfaces of scene objects from a viewpoint, the camera. Each pixel in the depth map image has a value that tells how far the corresponding pixel in the original image with the same coordinates is from the camera. The value for a depth map pixel is between 0 and 1. Assigning a “0” means the surface at that pixel coordinate is far from the camera, and assigning a “1” means it is closest to the camera.

An image can include, but is not limited to, the visual representation of objects, shapes, and features of what appears in a photo or video frame. According to certain embodiments, an image may be captured by a digital camera (as part of a video), and may be realized in the form of pixels defined by image sensors of the digital camera.

In certain embodiments, an image, as used herein, may refer to the visual representation of the electrical values obtained by the image sensors of a digital camera. An image file may refer to a form of the image that is computer-readable and storable in a storage device. In certain embodiments, the image file may include, but is not limited to, a .jpg, .gif, and .bmp, and a frame in a movie file, such as, but not limited to, a .mpg, and .mp4. The image file can be reconstructed to provide the visual representation (“image”) on, for example, a display device. Further, the subject techniques are applicable to both still images and moving images (e.g, a video).

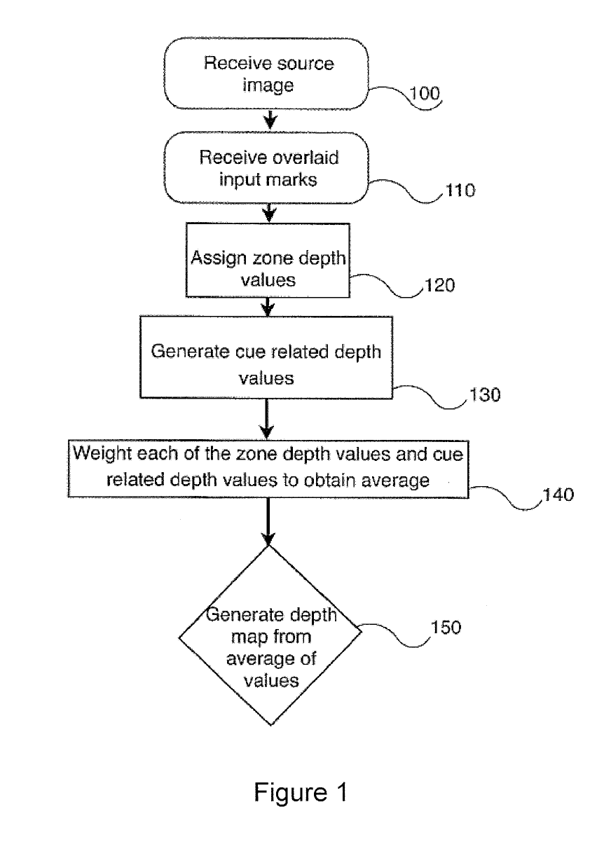

In at least one aspect, the present invention provides methods and software for providing three-dimensional information from a two-dimensional image and converting such two-dimensional images into three-dimensional images. As illustrated in FIG. 1, the methods described herein generate depth maps from overlaid input marks, or scribbles, and various visual cues of an input source image. A source image 100 to be analyzed is received. Input marks are then overlaid onto the source image 110 to segment the image into one or more zones. Zone depth values are assigned 120 for each of the zones segmented by the input marks. In some embodiments, all pixels within a particular zone are assigned the same depth values. One or more visual cue related depth values are automatically generated 130. In some embodiments, the cue related depth values are generated independently of the input marks. In some embodiments, the cue related depth values are determined for each individual pixel in the image. The method further includes weighting each of the zone depth values and one or more cue related depth values to obtain an average depth value 140. From the average depth values, a depth map of the image is obtained 150.

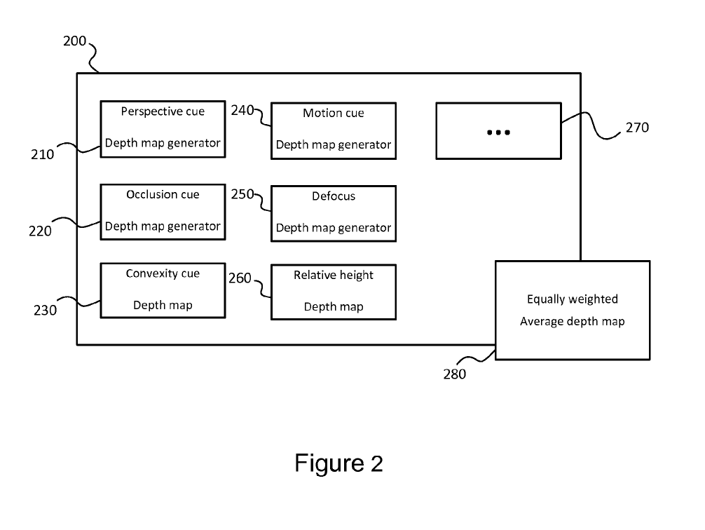

Referring to FIG. 2, various visual cues 200 are utilized to automatically generate depth values of the various zones and objects shown in an input source image. The visual cues include perspective cues 210, occlusion cues 220, convexity cues 230, motion cues 240, defocus cues 250, relative height cues 260, and others 270 (indicated as “ . . . ”). Future visual cues can be added to the methods and software described herein as needed. The depth values obtained from the visual cue analyses are then equally weighted and averaged to get a depth map 280. The average depth values obtained from the visual cues may also be averaged with the zone depth values obtained from the overlaid marks to obtain the final average depth value for determining the depth map of the image. In alternative embodiments, each of the zone depth values obtained from the overlaid marks are weighted with the cue related depth values to obtain the average depth value for finalizing the depth map of the source image.

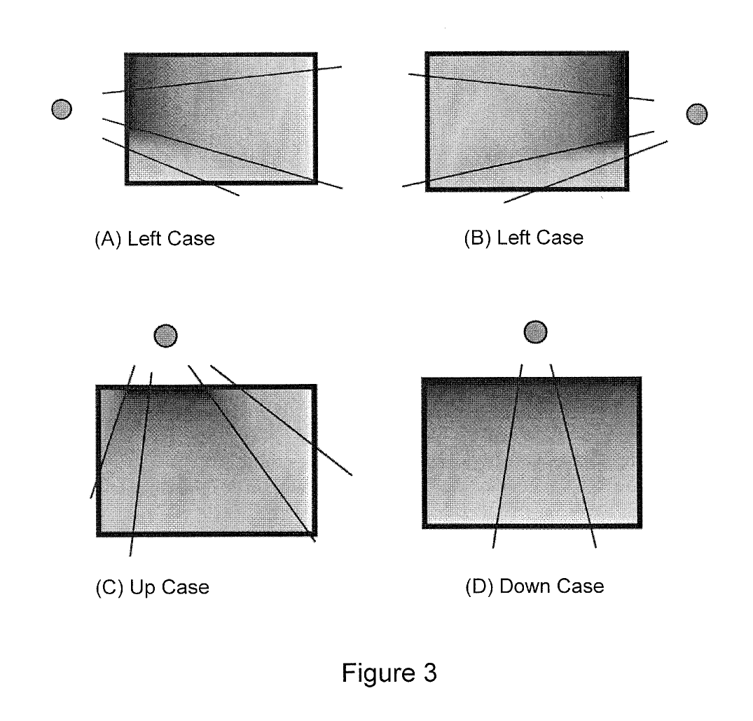

Perspective cue (Linear perspective): Linear perspective refers to the fact that parallel lines, such as railroad tracks, appear to converge with distance, eventually reaching a vanishing point at the horizon (a vanishing point is one of possibly several points in a 2D image where lines that are parallel in the 3D source converge). The more the lines converge, the farther away they appear to be. First, edge detection is employed to locate the predominant lines in the image. Then, the intersection points of these lines are determined. The intersection with the most intersection points in the neighborhood is considered to be the vanishing point. The major lines close to the vanishing point are marked as the vanishing lines. Between each pair of neighboring vanishing lines, a set of gradient planes is assigned, each corresponding to a single depth level. The pixels closer to the vanishing points are assigned a larger depth value and the density of the gradient planes is also higher. FIG. 3 illustrates the process and the resulting depth map of an embodiment where a darker grey level indicates a large depth value.

Perspective cue (Aerial perspective): Images of outdoor scenes are usually degraded by the turbid medium (water-droplets, particles, etc.) in the atmosphere. Haze, fog, and smoke are such phenomena due to atmospheric absorption and scattering. The irradiance received by the camera from the scene point is attenuated along the line of sight. Furthermore, the incoming light is blended with the airlight (ambient light reflected in the line of sight by atmospheric particles). The degraded images lose the contrast and color fidelity. On haze-free outdoor images, in most of the non-sky patches (blue color), at least one color channel has very low intensity at some pixels. In other words, the minimum intensity in such a patch should have a very low value.

minc∈{r,g,b}(miny∈Ω(x)(Image(y))) is a very low value

r,g,b are the color channels and Ω is a surrounding zone of pixel x. However, haze and other atmospheric absorption and scattering phenomena appear commonly in outdoor pictures. The more distant the object in the picture is, the stronger the haze/scattering. As such, if one calculates using the previous formula, you will get higher values. Aerial perspective cue provides acceptable results for near and mid-range distances. Since, generally, the user will draw scribbles on foreground objects, the aerial perspective cue is applied. The principal causes of error in the estimation will be hidden because of the pasting of this user assigned depth on the marked segments.

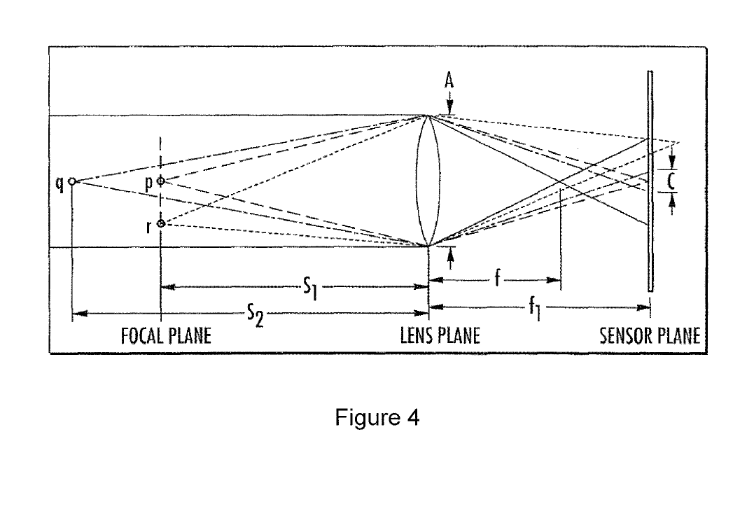

Shape from Shading Cue: The gradual variation of surface shading in the image encodes the shape information of the objects in the image. Shape-from-shading (SFS) refers to the technique used to reconstruct 3D shapes from intensity images using the relationship between surface geometry and image brightness. SFS is a well-known ill-posed problem just like structure-from-motion in the sense that the resolution may not exist, the solution may not be unique, or it may not depend continuously on the data. In general, SFS algorithms make use of one of the following four reflectance models: pure Lambertian, pure specular, hybrid or more complex surfaces, of which, Lambertian surface is the most frequently applied model because of its simplicity. A uniformly illuminated Lambertian surface appears equally bright from all viewpoints. Besides the Lambertian model, the light source is also assumed to be known and orthographic projection is usually used. The relationship between the estimated reflectance map R(p,q) (see FIG. 4) and the surface slopes offers the starting point to many SFS algorithms.

Depth from defocus cue: The two principal causes of image defocus are limited depth of field (DOF) and lens aberrations that cause light rays to converge incorrectly onto the imaging sensor. Defocus of the first type is illustrated by the point “q” in FIG. 4 and is described by the thin lens law:

1/S1+1/f1=1/f (1)

where f is the focal length of the lens, S1 is the distance of the focal plane in the scene from the lens plane, and f1 is the distance from the lens plane to the sensor plane. The blurred spot caused by limited DOF or lens aberrations is called the circle of confusion. From equation (1) and the relationship of parameters in FIG. 4, the diameter of circle of confusion is:

C=A×(|S2−S1|/S2)×f/|S1−f| (2)

which concurs that the diameter C increases as the distance of a point from the focal plane |S2−S1| increases, and C decreases as the aperture diameter A decreases. For defocus blur caused by lens aberrations, C increases as the distance |r−p| increases.

Depending on the shape and diffraction of the aperture, the circle of confusion is not strictly a circle. The intensity within the circle of confusion can be assumed to be uniform. However, if the effects of diffraction and the lens system are taken into account, the intensity within the blur circle can be reasonably approximated by a Gaussian distribution. Thus, the defocus blur effect can be formulated as the following convolution:

Iob=I×h+n (3)

where Iob is the observed image, I represents an in-focus image of the scene, h is a spatially-varying Gaussian blur kernel, and n denotes additive noise. Under this configuration, the estimation of h for each image pixel is equal to the estimation of a defocus blur scale map (i.e. defocus map).

There are several ways to obtain an estimation of the degree of defocus at different parts of an image scene. All of them measure the degree of sharpness at the edges. In general, well focused zones are said to be closer to camera and, the bigger the defocus, the more distant the object is; however, this is not always true. If the shoot focuses on a middle distance object, background and foreground objects tend to be defocused. In embodiments provided, the segmentation obtained via the one or more input marks overlayed on the image provides the distance assigned to well-focused objects. Previously segmented zones will be assigned the input mark (i.e., scribble) depth. If no scribble information is provided, the depth from defocus cue will always assign a closer to camera distance to well focused objects in the scene. If the picture to process is focused on middle distance objects, foreground shapes in the frame will be defocused (more or less according to the depth of field lens of the camera which shot the scene). The purpose of scribbles will be to shift function assigned values according to the scribble given values.

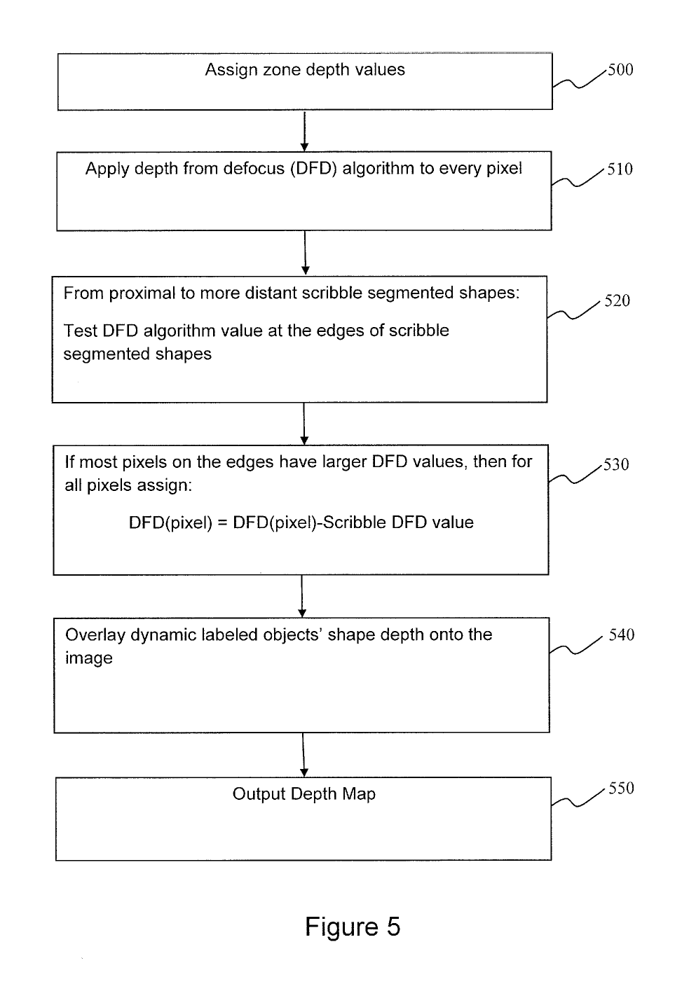

FIG. 5 illustrates how the depth from defocus cue is applied to an input image. Once the zone depth values are applied using the overlaid input marks (500), for each input image the depth from defocus algorithm is applied to every pixel (510). From proximal to more distant input mark (scribble) segmented shapes, test the depth from defocus (DFD) algorithm value at the edges of input mark (scribble) segmented shapes (520). If most pixels on the edges have largest depth from defocus values (530), then for all pixels assign:

DFD(pixel)=DFD(pixel)−scribble DFD value

Next, the dynamic labeled objects' shape depth is overlaid onto the image (540). This process provides the depth map generated from the depth from defocus cue (550).

“Shape depth” refers to the value of depth given to corresponding scribble which segments surrounding pixels resulting in a segmenting zone, or shape. “Dynamic” refers to the object being in motion in the image frame.

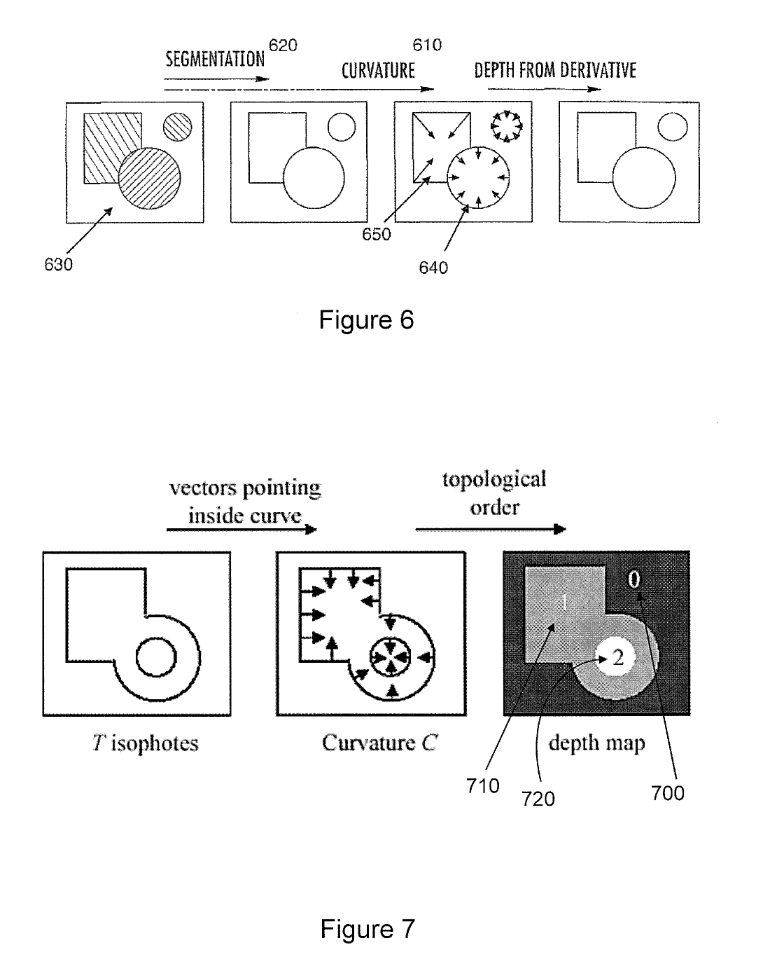

Convexity/curvature cue: Convexity is a depth cue based on the geometry and topology of the objects in an image. The majority of objects in 2D images have a sphere topology in the sense that they contain no holes, such as closed grounds, humans, telephones, etc. It is observed that the curvature of object outline is proportional to the depth derivative and can thus be used to retrieve the depth information. FIG. 6 illustrates the process of the depth-from-curvature algorithm. The curvature (610) of points on a curve can be computed from the segmentation (620) of the image (630). A circle has a constant curvature and thus a constant depth derivative along its boundary (640), which indicates that it has a uniform depth value. A non-circle curve, such as a square, does not have a constant curvature (650). A smoothening procedure is needed in order to obtain a uniform curvature/depth profile. After the smoothing process, each object with an outline of uniform curvature is assigned one depth value.

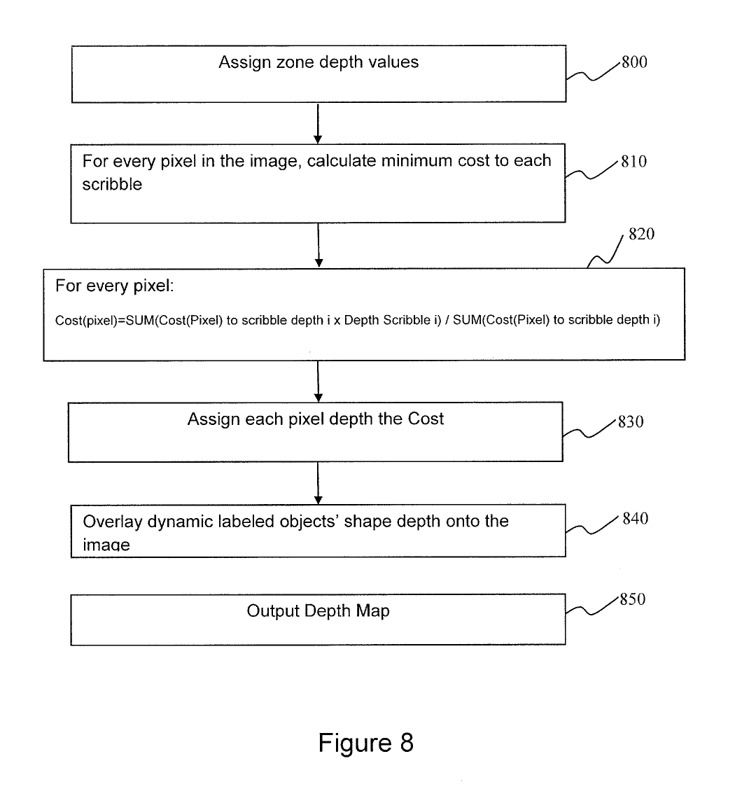

To apply the depth-from-curvature approach in embodiments of the present invention, isophotes are used to represent the outlines of objects in an image. As used herein, an “isophote” is a closed curve of constant luminance and always perpendicular to the image derivatives. An isophote with an isophote value, T, can be obtained by thresholding an image with the threshold value that is equal to T. The isophotes then appear as the edges in the resulting binary image. FIG. 7 illustrates how to derive the depth map for isophotes of value T. The topological ordering may be computed during the process of scanning the isophote image and flood-filling all 4-connected regions. First, the image border pixels are visited. Each object found by flood-filling is assigned a depth value of “0” (700). Any other object found during the scan is then directly assigned a depth value equal to one (1) plus the depth from the previous scanned pixel (710, 720). In the end, a complete depth map of isophotes with a value of T is obtained. Repeating this procedure for a representative set of values of T, e.g. [0, 1], for an image, the final depth map may be computed by adding or averaging all the T depth maps. Furthermore, there are other visual cues where 3D information may be obtained by the present invention: depth from motion, depth from occlusions, depth from atmosphere scattering, etc.

Finally, in this module there is the depth map weighted contribution mixer which utilizes a set of parameters given by the user after he has studied the different depth maps suggested by the application and merges the selected better suited depth maps according to a quantitative contribution to the desired depth map. The weighted contribution is built this way: if Da, Db, Dc are depth maps obtained via a, b and c visual cues, the weighted depth map, Dw, will be:

Dw =((contribution Da)×Da+(contribution Db)×Db+(contribution Dc)×Dc)

where Contribution Db+Contribution Db+Contribution Dc=1. The different contributions are numbers provided by the user in the range [0,1].

Relative Height cue: This cue stands for the fact that most of time, objects in the scene are closer to the camera than they appear in the bottom part of the picture and more distant as they appear closer to the top of the scene. This fact is usually implemented in a picture just as evaluating pixel cost of all pixels in the frame to a bottom line. The larger the cost, the more distant the pixel is.

The way to improve the construction of the depth map associated with this visual cue consists of evaluating pixel costs in the whole scene minus the areas segmented by the scribbles to some particular pixels instead of the common bottom line. These particular pixels will be the set of pixels belonging from the different scribbles in the picture. The resulting cost of each pixel will be an average of costs of sums of the minimum cost to each different depth value scribbles multiplied by its depth value.

The cost function used in this process is it not isotropic; the cost for a pixel to ‘move’ to the pixel in an inferior row will be multiplied by a factor ∥B∥>1.

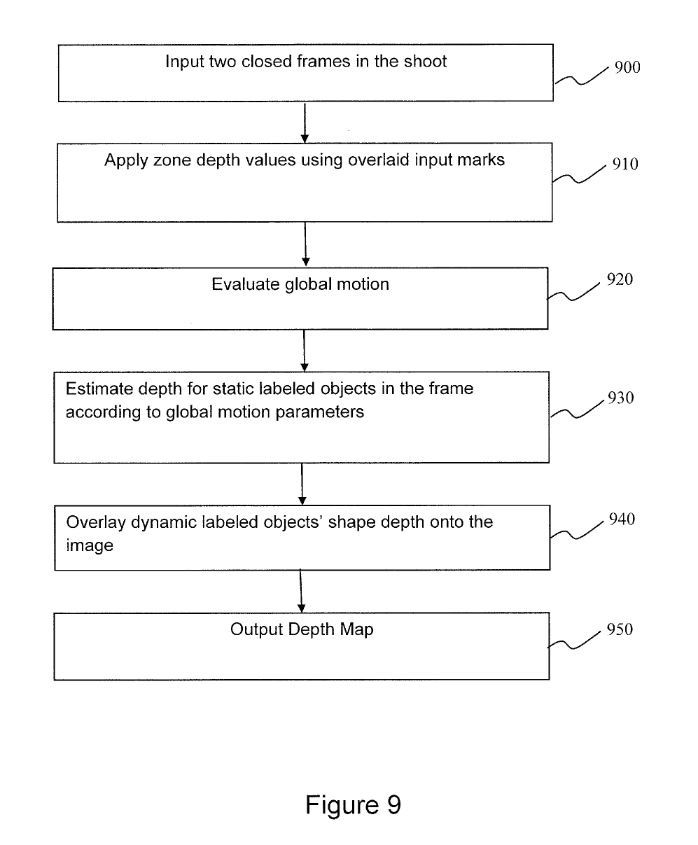

FIG. 8 illustrates how the relative height cue is applied to an input image with scribbles in embodiments provided. Once the zone depth values are applied using the overlaid input marks (scribbles) (800), the minimum cost to each scribble is calculated for every pixel in the image (810). For every pixel (820):

Cost(pixel)=SUM(Cost(Pixel) to scribble depth I×scribble depth i)/SUM(Cost(Pixel) to scribble depth i).

Next, each pixel depth in the image is assigned the cost (830). Then, the dynamic labeled objects' shape depths (depths of objects in motion in the image) are overlaid onto the image (840) to obtain the relative height—scribble depth map (850).

Motion cue: Motion, when it exists in the scene, is many times the better cue to obtain a reliable depth map. But the main problem appears when no ideal conditions appear: static and moving objects in the frame appear so many times. There are several methods to classify moving and stationary objects in the scene, but there are always assumptions to be made.

In some embodiments, global motion is evaluated in the scene by analyzing flow at the image borders. With this, one knows about the kind of motion camera: Translation, rotation, zoom. Next, the methods and software evaluate the static marked segments to define their distance to the camera while only making use of the static attribute, not the associated depth. Finally, the dynamic elements are added onto the depth map associated with motion cue.

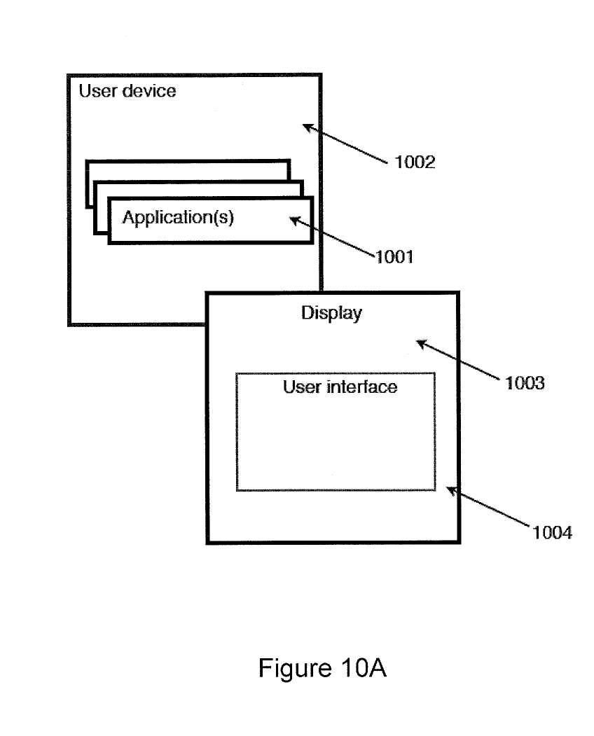

FIG. 9 illustrates how motion cue is applied to improve depth map acquisition in embodiments provided. Global motion is the way to describe the motion in a scene based on a single affine transform A geometric affine transform is a transformation of points in a space which preserves points, straight lines and planes, for example, translation, rotation, scaling, etc.

The information obtained is about how a frame is panned, rotated and zoomed such that it can be determined if the camera moved, or was zoomed, among two frames. Camera movement, or zooming, requires analysis of the frame's border pixels (5-10% of image width/height). It's assumed the foreground (and very likely moving and foreground objects) appear at the center of the picture and most of border zones correspond to background and again very likely static parts of the scene.

For this embodiment's algorithm, images from two closed frames in a shoot are input (900). “Two close frames” refer to frames separated more than 1 or more frames while still representing a ‘consistent view. For example, even if global motion exists, it can be a very slow motion (such as scenes where the frame by frame pixel maximum movement is two pixels). The ‘disparity information will be very poor so only two layers of depth are attainable. As such, if a frame is utilized, for example two steps later, a maximum movement of 4 pixels is observed, which distinguishes four possible values for depth in the estimation.

Once the zone depth values are applied using the overlaid input marks (scribbles) (910), the global motion of the frames is evaluated (920). Global motion is a particular motion estimation case when only interested in determining a pixel's translation at the frame's border image, about a 5% width of the picture coordinates. A pixel by pixel translation is not necessarily done; however, a linear square fitting curve provided by the pixel by pixel collected information is performed to obtain a predominant motion vector for the whole exterior area of the picture. The depth for static labeled objects (labeled by scribbles) in the frame is estimated according to the global motion parameters (930). Next, the dynamic labeled objects' shape depths (depths of moving objects) are overlaid onto the image (940) to get the resulting motion cue—scribbles depth map (950).

The depth map analyses described convey relative depth information; as such, there is no problem if one or more of the cues provides no information (e.g., a 100% focused image will give a grayscale homogeneous color except for the scribbles' segmented regions). This will not change the relative depth among objects in the scene. Every depth cue information contribution provides relative depth ordering. It is assumed most cues will provide accurate information about the 3-dimensional structure of the scene. So, if a particular cue gives no information, global weighted depth ordering information will not be altered, but relative depth values will get closer.

Additional visual cues can be added to the processes described herein (e.g., Luminance, Texture, etc.). As only relative depth is given, and these additional cues' results are improved by the scribbles information for reliability, an equally weighted average will not alter the depth ordering.

Next, given a depth map for a given cue, the method tunes the set of initial conditions and parameters for getting the expected values at the objects segmented by the input marks overlaid on the input image. Once all of the visual cues are analyzed, the depth values are equally weighted to get a final averaged depth map, and the final post processing step is tuning the depth map histogram to get the right distance ratios.

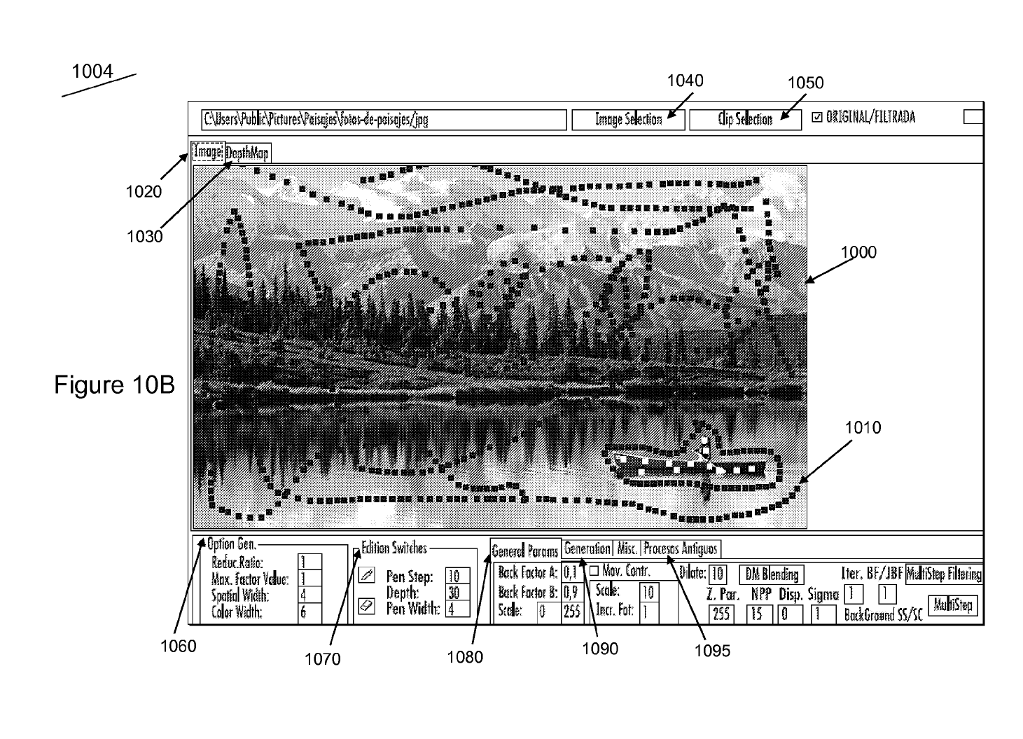

As illustrated in FIG. 10A, in one embodiment, the 2D-3D image conversion can be accomplished via one or more program applications (1001) executed on a user device (1002), such as a computer (which includes components, such as a processor and memory, capable of carrying out the program applications). Certain techniques set forth herein may be described in the general context of computer-executable instructions, such as program applications, executed by one or more computers or other devices. Generally, program applications (1001) include routines, programs, objects, components, and data structures that perform particular tasks or implement particular abstract data types. In various embodiments, the functionality of the program applications (1001) may be combined or distributed as desired over a computing system or environment. Those skilled in the art will appreciate that the techniques described herein may be suitable for use with other general purpose and specialized purpose computing environments and configurations. Examples of computing systems, environments, and/or configurations include, but are not limited to, personal computers, server computers, hand-held or laptop devices, multiprocessor systems, microprocessor-based systems, programmable consumer electronics, and distributed computing environments that include any of the above systems or devices. The computing systems may additionally include one or more imaging peripherals (1003), such as a display, and input devices, such as a mouse or other pointing device. It would also be understood by those skilled in the art that additional peripherals, such as three-dimensional viewing glasses, may be necessary to view resulting three-dimensional images.

It should be appreciated by those skilled in the art that computer readable media includes removable and nonremovable structures/devices that can be used for storage of information, such as computer readable instructions, data structures, program applications, and other data used by a computing system/environment, in the form of volatile and non-volatile memory, magnetic-based structures/devices and optical-based structures/devices, and can be any available media that can be accessed by a user device. Computer readable media should not be construed or interpreted to include any propagating signals or carrier waves.

In one embodiment, a program application with a user interface (1004) and/or system is provided for performing the methods of the embodiments described herein. The user interface may include the hardware and/or program applications necessary for interactive manipulation of the two-dimensional (2D) source image into a three-dimensional (3D) image. The hardware/system may include, but is not limited to, one or more storage devices for storing the original source digital image(s) and the resulting three-dimensional products, and a computer containing one or more processors.

The hardware components are programmed by the program applications (1001) to enable performance of the steps of the methods described herein. The program applications (1001) send commands to the hardware to request and receive data representative of images, through a file system or communication interface of a computing device, i.e., user device.

Once the image is received into the system, a two-dimensional image is displayed on one or more displays (1003) through the user interface (1004). Through various steps in the methods provided, the program applications (1001) provide a series of images that characterize various visual cues, such as perspective and motion cues. The user interface may also include a variety of controls that are manipulated by windows, buttons, dials and the like, visualized on the output display.

In one embodiment, a computer program product stored in computer readable media for execution in at least one processor that operates to convert a two-dimensional image or set of images (video) to a three-dimensional image is provided. The instructions utilize at least a first programming application (1001) for determining a depth map value set utilizing input scribbles and various visual cues and additional programming applications (1001) for inputting the depth map value set such that a user has the ability to adjust or change the automated results of the depth map value set. Furthermore, preferred output depth maps, or a weighted contribution of the set of generated depth maps, from the programming modules (1001) may be output. As such, editing of particular zones in a scene from the input source image may occur.

FIG. 10B illustrates an embodiment of a user interface (1004) of a program application (1001) of the present invention. An image (1000) is displayed on the interface (1004). Scribbles (input marks) (1010) can be received by the interface (1004) for overlay on the image to segment the image into zones. The interface (1004) provides input for adjustment of depth map and allows user input of depth values in the image. The user may scribble on the image, assigning desired depth values for the zones created on the image by the scribbles. This information received by the program application (1001) from the user allows the system/program application to segment the image into different objects or zones and provide resulting depth values. The zone depth values are then utilized when generating the cue related depth values, as previously described herein, to generate a depth map. An exemplary interface (1004) may include various inputs, such as, but not limited to, an interactive input for: image processing and scribble drawing (1020); obtained depth map on different steps: Scribble only segmentation, any depth cue obtained depth map, merged and/or weighted contibution deph maps, etc. (1030); selecting a single image for a particular picture to be converted (1040); selecting a clip sequence to work with (1050); (option generator) for allowing a previous anisotropic filter to the frame (and subsequence ones) to process (he main reason for this is cleaning the image of noise, allowing a better segmentation in latter steps in the workflow) (1060); (edition switches) for allowing selection of the pen attributes to draw the scribbles (the text box named Depth conveys the depth value assigned to the pen to draw scribbles over the picture) (1070); (General parameters for depth map generation) Back Factor A/B and Scale limits are the parameters for depth from the height visual cue, (Mov. Controls) related input boxes, (Scale and Incr. Fot.) are parameters for global motion estimation, Dilate offers the ability to apply morphologycal operation on the obtained depth map, DM Blending merges all cue-scribble aided depth maps for scribble biased segmentation, Z. Par, NPP, Disparity and Sigma are the parameters to generate the 3D image to watch, Iter. BF & JBF. Bilateral and Joint bilateral like filters to highly enhance the resulting depth map quality (1080); various switches for depth map propagation along the shoot based on key frame generated depth maps (1090); and a tab that contains 3d render functionality (1095).

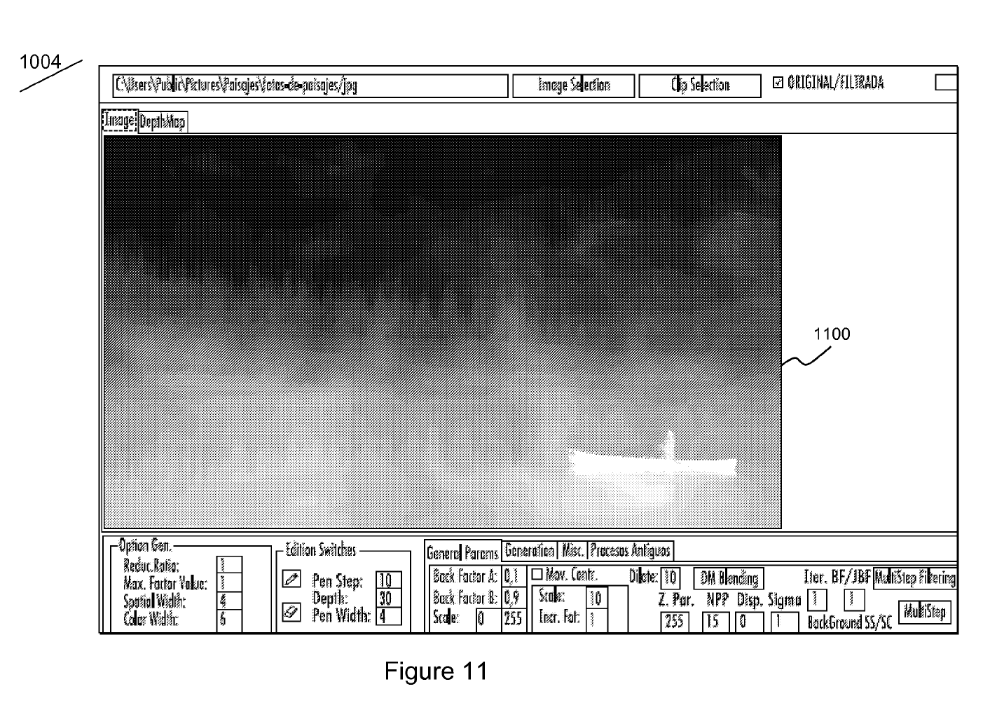

FIG. 11 illustrates a screen shot of an application interface (1004) with the merged (weighted average) of the zone depth values and cue related depth values to obtain the final depth map (1100).

The methods, systems and program applications described herein improve existing solutions for converting conventional 2D content into 3D content in that no manual shape segmentation is needed for every object in an image, no rotoscopy is needed, and no frame-by-frame actuation is needed. As manual operation is minimized, the methods will make 2D to 3D conversion a much faster process, resulting in time and cost savings.

The methods focus on giving the user (artist) the distance information of every object in a single image in an semi-automated way, utilizing initial artist input that enhances the subsequent automated visual cue depth map generation. The information provided by the methods herein will give a qualitative distance from the camera to the objects (e.g., object A is closer to the camera than object B; object C is much farther than object D). Then, the methods can provide a set of numbers such that this qualitative information can be converted into quantitative values.

Instead of generating a depth map per image, the processes disclosed herein allow the defining of a single depth map for an image, another one for a second image a few frames later, such as, for example, 20 or 50 images later depending on the ‘shoot action’, and then the processes described herein allow for interpolation of depth maps for intermediate images,

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method for obtaining a depth map, comprising:
receiving one or more image;
receiving one or more input marks overlayed on the one or more image that segment the one or more image into one or more zones;
assigning zone depth values for each of the zones;
generating cue related depth values utilizing the zone depth values and one or more cue related depth values;
weighting each of the zone depth values and cue related depth values to obtain an average depth value; and
generating a depth map of the image from the average depth values.

2. The method of claim 1, wherein the one or more cue related depth values are generated utilizing the assigned zone depth values for each of the zones.

3. The method of claim 1, wherein the one or more cue related depth values comprises a motion cue value.

4. The method of claim 1, wherein the one or more cue related depth values comprises a relative height cue value.

5. The method of claim 1, wherein the one or more cue related depth values comprises an aerial perspective cue value.

6. The method of claim 1, wherein the one or more cue related depth values comprises a depth from defocus cue value.

7. The method of claim 1, wherein the one or more cue related depth values are selected from the group consisting of a motion cue value, a relative height cue value, an aerial perspective cue value, a depth from defocus cue value, and combinations thereof.

8. The method of claim 1, wherein the one or more input marks segment the image into static or dynamic objects in the image.

9. The method of claim 1, wherein the one or more input marks segment the image into a zone containing one or more foreground objects.

10. The method of claim 1, wherein the one or more input marks segment the image into a zone containing one or more background objects.

11. A computer-readable storage medium having instructions stored thereon that cause a processor to perform a method of depth map generation, the instructions comprising steps for:
in response to receiving one or more input marks overlayed on one or more image that segment the image into one or more zones, assigning zone depth values for one or more of the zones;
generating one or more cue related depth values;
weighting each of the zone depth values and one or more cue related depth values to obtain an average depth value; and
generating a depth map of the one or more images from the average depth values.

12. The medium of claim 11, wherein the one or more cue related depth values are selected from the group consisting of a motion cue value, a relative height cue value, an aerial perspective cue value, a depth from defocus cue value, and combinations thereof.

13. The medium of claim 11, wherein the one or more input marks segment the image into static or dynamic objects in the image.

14. The medium of claim 11, wherein the one or more input marks segment the image into a zone containing one or more foreground objects.

15. The medium of claim 11, wherein the one or more input marks segment the image into a zone containing one or more background objects.
